(19) United States
(12) Patent Application Publication
(10) Pub. No.: US 2007/0159478 A1
(43) Pub. Date: Jul. 12, 2007

(54) Image display apparatus for controlling luminance and the luminance controlling method thereof

(75) Inventors: Dong-bum Choi, Suwon-si (KR); Moon-cheol Kim, Suwon-si (KR); Sang-jin Lee, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/499,676

(22) Filed: Aug. 7, 2006

(30) Foreign Application Priority Data
Jan. 9, 2006 (KR) 10-2006-0002446

(51) Int. Cl. G06T 15/50

(52) U.S. Cl. 345/426

(57) ABSTRACT

An image display apparatus capable of controlling a luminance and a luminance controlling method are provided. The image display apparatus includes a luminance sensor to measure a surrounding luminance, a luminance change sensor to sense a change of the surrounding luminance using the measured surrounding luminance, a luminance energy comparator to compare the sensed change of the surrounding luminance with a preset threshold and to compare a maximal eye adaptation in the measured surrounding luminance with a maximal luminance energy of a display, and a luminance adjustment controller to adjust a luminance of the display according to the eye adaptation using the comparison result of the luminance energy comparator.

### CROSS-REFERENCE TO RELATED APPLICATIONS

This application claims priority from of Korean Patent Application No. 10-2006-0002446 filed on Jan. 9, 2006, in the Korean Intellectual Property Office, the disclosure of which is incorporated herein by reference.

### BACKGROUND OF THE INVENTION

1. Field of the Invention

The present invention relates to an image display apparatus and a luminance controlling method thereof. More particularly, the present invention relates to an image display apparatus that controls luminance of a display in view of a luminance energy bandwidth of the display and an eye's adaptability according to a change of a surrounding luminance when a magnitude of surrounding light source, that is, a surrounding luminance, is changed.

2. Description of the Related Art

An image display apparatus displays an image corresponding to an image signal received from an outside source, and an image stored in a storage medium. Generally, the image display apparatus may include any of a video cassette recorder (VCR), a digital versatile disk (DVD) player, a compact disk (CD) player, a hard disk drive (HDD) player, a camcorder, a mobile phone, a personal digital assistant (PDA), a television (TV), a set-top box and a personal computer (PC).

The image display apparatus displays an image with a luminance that is preset or set by a user when displaying an image. Meanwhile, a lamp may be turned on so that the surroundings suddenly becomes bright while an image is displayed in a dark place, or a lamp may be turned off so that the surroundings suddenly becomes dark while an image is displayed in a bright place.

At this time, a conventional image display apparatus adjusts a luminance of a display according to a change of the surrounding luminance. In detail, the conventional image display apparatus has a display luminance sensor and a surrounding luminance sensor. When displaying an image, the image display apparatus senses an amount of light of the displayed image by the display luminance sensor, and an amount of surrounding light by the surrounding luminance sensor. The image display apparatus calculates a change of the sensed surrounding luminance to adjust luminance of the display according to the change of the surrounding luminance.

FIG. 1 is a graph for explaining a related art method of controlling luminance. Referring to FIG. 1, the graph shows a dark adaptation curve when a bright status turns to a dark status. The horizontal axis refers to time, that is, the minutes in dark, and the vertical axis refers to an amount of light, that is, luminance, shown as a threshold intensity.

If the amount of the sensed surrounding lights decreases and it becomes dark, the conventional image display apparatus adjusts the luminance of the display according to the dark adaptation curve. For example, if the threshold intensity of the luminance of the graph is changed from 8 to 6, that is, it becomes darker, the luminance of the display apparatus takes approximate 7 minutes to adapt. Accordingly, if the threshold intensity of the sensed surrounding lights is changed from 8 to 6, the image display apparatus does not suddenly reduce the amount of light of the displayed image, that is, the luminance of the display, but gradually adjusts it according to the adaptation time. Conversely, if a bright status turns to a dark status, the conventional image display apparatus adjusts the luminance of the display according to a light adaptation curve. At this time, the conventional image display apparatus does not consider the luminance energy bandwidth of the display that has a limit to be expressed, but adjusts the luminance of the display. Accordingly, the luminance energy bandwidth that can be sensed by a user's eyes may be reduced.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides an image display apparatus that can adjust luminance in view of an expressable luminance energy bandwidth of a display and a luminance energy bandwidth that can be sensed by human eyes when surrounding luminance is changed.

The present invention also provides a luminance controlling method that can adjust luminance in view of an expressable luminance energy bandwidth of a display and a luminance energy bandwidth that can be sensed by human eyes when surrounding luminance is changed.

According to an aspect of the present invention, there is provided an image display apparatus including a luminance sensor to measure a surrounding luminance, a luminance change sensor to sense a change of the surrounding luminance using the measured surrounding luminance, a luminance energy comparator to compare the sensed change of the surrounding luminance with a preset threshold and to compare a maximal eye adaptation in the measured surrounding luminance with a maximal luminance energy of a display, and a luminance adjustment controller to adjust a luminance of the display according to the eye adaptation using the comparison result of the luminance energy comparator.

If it is determined that the sensed changed of the surrounding luminance is less than the preset threshold, the luminance adjustment controller may maintain the luminance of the display.

If it is determined that the sensed change of the surrounding luminance is greater than the preset threshold, the luminance energy comparator may compare the maximal eye adaptation in the measured surrounding luminance with the maximal luminance energy of the display.

The luminance adjustment controller may maintain the luminance of the display if the maximal eye adaptation in the measured surrounding luminance is greater than the maximal luminance energy of the display, and reduce the luminance of the display if the maximal eye adaptation in the measured surrounding luminance is less than the maximal luminance energy of the display.

In a range where the luminance energy bandwidth that can be sensed by the eyes becomes wide if the surrounding luminance is changed, the luminance adjustment controller may maintain the luminance of the display to expand the luminance energy bandwidth of the eyes.

The luminance adjustment controller may adjust the luminance of the display according to the eye adaptation from a time when the luminance energy of the display becomes maximal according to the change of the surrounding luminance.

The eye adaptation refers to an adaptability degree of the eyes for the change of surrounding luminance as time goes by.

According to an aspect of the present invention, there is provided a luminance controlling method of an image display apparatus including operations of measuring a surrounding luminance, sensing a change of the surrounding luminance using the measured surrounding luminance, comparing the sensed change of the surrounding luminance with a preset threshold and comparing a maximal eye adaptation in the measured surrounding luminance with a maximal luminance energy of a display, and adjusting a luminance of the display according to the eye adaptation using the comparison result.

If it is determined that the sensed changed of the surrounding luminance is less than the preset threshold, the operation of adjusting the luminance maintains the luminance of the display.

If it is determined that the sensed change of the surrounding luminance is greater than the preset threshold, the operation of comparing may compare the maximal eye adaptation in the measured surrounding luminance with the maximal luminance energy of the display.

The operation of adjusting the luminance maintains the luminance of the display if the maximal eye adaptation in the measured surrounding luminance is greater than the maximal luminance energy of the display, and reduces the luminance of the display if the maximal eye adaptation in the measured surrounding luminance is less than the maximal luminance energy of the display.

In a range where the luminance energy bandwidth that can be sensed by eyes becomes wide if the surrounding luminance is changed, the operation of adjusting the luminance may maintain the luminance of the display to expand the luminance energy bandwidth of the eyes.

The operation of adjusting the luminance may adjust the luminance of the display according to the eye adaptation from a time when the luminance energy of the display becomes maximal according to the change of the surrounding luminance.

The eye adaptation may refer to an adaptability degree of the eye for the change of the surrounding luminance as time goes by.

### BRIEF DESCRIPTION OF THE DRAWINGS

The above aspects and features of the present invention will be more apparent by describing certain exemplary embodiments of the present invention with reference to the accompanying drawings, in which:

FIG. 1 is a graph for explaining a related art luminance controlling method;

FIG. 2 is a block diagram of an image display apparatus according to an exemplary embodiment of the present invention;

FIG. 3 is a graph for explaining a luminance controlling method of an image display apparatus according to an exemplary embodiment of the present invention;

FIG. 4 is a graph for explaining a luminance adjustment method of an image display apparatus according to another exemplary embodiment of the present invention;

FIG. 5 is a graph for explaining a luminance adjustment method of an image display apparatus according to yet another exemplary embodiment of the present invention; and

FIG. 6 is a flowchart of a luminance controlling method of an image display apparatus according to an exemplary embodiment of the present invention.

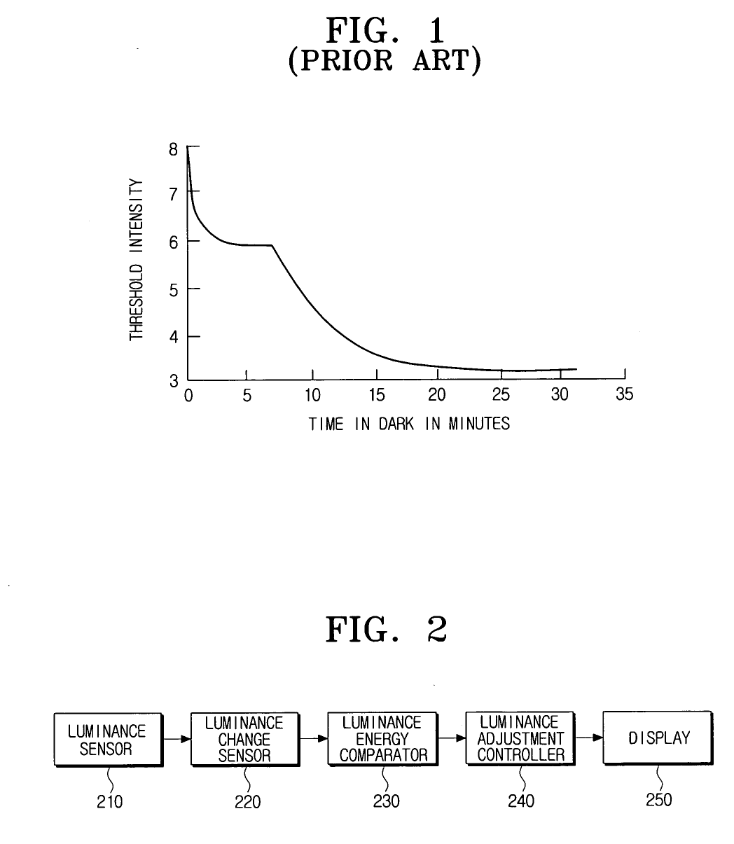

### DETAILED DESCRIPTION OF THE EXEMPLARY EMBODIMENTS

Exemplary embodiments of the present invention will be described in detail with reference to the annexed drawings. In the drawings, the same elements are denoted by the same reference numerals throughout the drawings. In the following description, detailed descriptions of known functions and configurations incorporated herein have been omitted for conciseness and clarity.

FIG. 2 is a block diagram of an image display apparatus according to an exemplary embodiment of the present invention.

When surrounding luminance is changed, the image display apparatus considers a luminance energy bandwidth that can be expressed by a display and a luminance energy bandwidth that can be sensed by human eyes, and simultaneously considers an adaptability of the eyes according to a change of a surrounding luminance to adjust a luminance of a display. The adaptability of the eyes refers to an adaptability degree of the eyes for the change of surrounding luminance as time goes by.

In detail, the image display apparatus maintains a luminance of the display to expand a luminance energy bandwidth of the eyes in a range where a luminance energy bandwidth that sensed by human eyes becomes wide when a magnitude of a surrounding light source, that is, a surrounding luminance, is changed. The image display apparatus considers the adaptability of the eyes to adjust the luminance of the display from a point where the luminance energy bandwidth of the eyes becomes maximal according to the change of the surrounding luminance.

Referring to FIG. 2, the image display apparatus includes a luminance sensor 210, a luminance change sensor 220, a luminance energy comparator 230, a luminance adjustment controller 240, and a display 250.

The luminance sensor 210 measures a magnitude of a surrounding light source, that is, a surrounding luminance. The luminance change sensor 220 senses a surrounding luminance change using the surrounding luminance measured by the luminance sensor 210.

The luminance energy comparator 230 compares the surrounding luminance change sensed by the luminance change sensor 220 with a preset threshold. If the surrounding luminance change is greater than the preset threshold, the luminance energy comparator 230 compares a maximal adaptability of the eyes (hereinafter “maximal eye adaptation”) in the measured surrounding luminance with a maximal luminance energy of the display.

According to the comparison result of the luminance energy comparator 230, the luminance adjustment controller 240 adjusts a luminance of the display 250. On the display 250, an image is displayed with a luminance adjusted by the luminance adjustment controller 240.

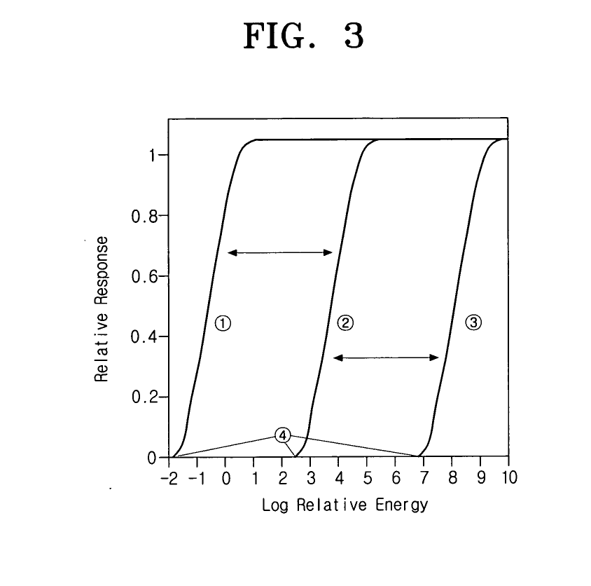

FIG. 3 is a graph for explaining a luminance adjustment method of an image display apparatus according to an exemplary embodiment of the present invention.

Referring to FIG. 3, the graph illustrates eye adaptation curves \textcircled{1}, \textcircled{2} and \textcircled{3} according to the change of the incident luminance energy. The horizontal axis refers to a luminance relative energy on a logarithmic scale, and the vertical axis refers to a relative response of the eyes according to the log relative energy. \textcircled{4} refers to a log relative energy sensed as black by the eyes.

As can be seen from the graph, the eye adaptation curves \textcircled{1}, \textcircled{2} and \textcircled{3} are not instantly adapted but moved based on an energy depending on time as the luminance energy incident on the eyes, that is, an amount of light, is changed. An eye adaptation function is calculated by the eye adaptation curves \textcircled{1}, \textcircled{2} and \textcircled{3}. For example, when the log relative energy is 4, the eye adaptation curve is shown as curve \textcircled{2}, but when the amount of the light is changed and the log relative energy increase to 8.5, the eye adaptation curve is shown as curve \textcircled{3}.

If the amount of the surrounding light is changed and the whole amount of light incident on the eyes is changed, the eyes recognize the same display screen as changed images as time goes by. Therefore, the luminance adjustment controller 240 controls the light source of the display to adjust the luminance according to the eye adaptation curve, that is, the adaptability of eyes, depending on the amount of the surrounding light change, that is, the change of log relative energy. At this time, when a bright status turns to a dark status, the luminance adjustment controller 240 reduces the luminance of the display so that power consumption can decrease.

However, since the display luminance decreases, the luminance energy bandwidth of the display and that of eyes may be limited. Accordingly, the luminance adjustment controller 240 controls the display luminance in view of the luminance energy bandwidth that can be displayed by the display and the luminance energy bandwidth that can be sensed by eyes.

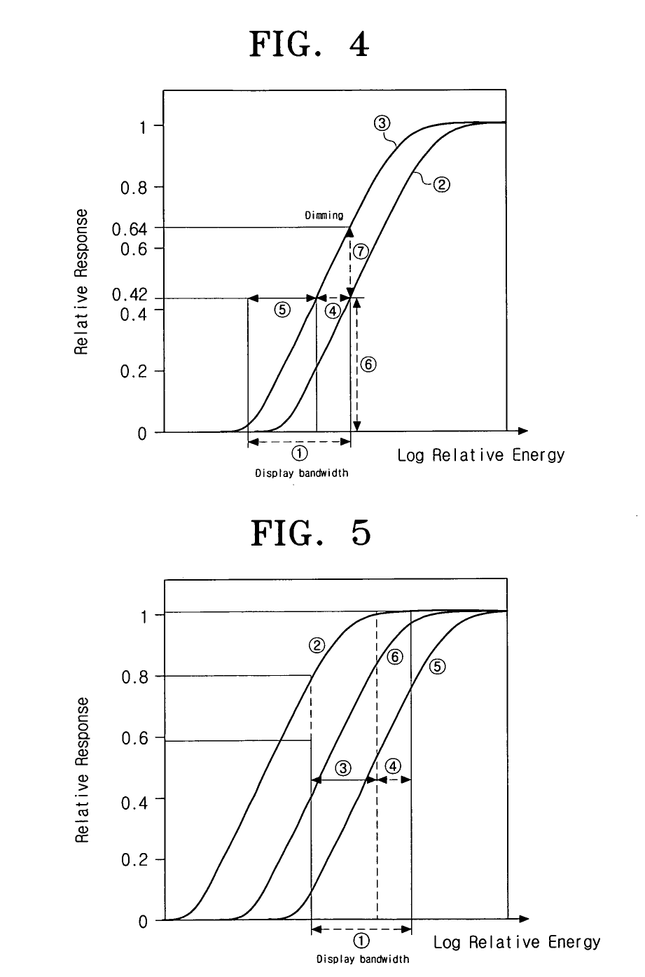

FIG. 4 is a graph for explaining a luminance adjustment method of an image display apparatus according to another exemplary embodiment of the present invention.

FIG. 4 is a graph showing an example of changes of eye adaptation curves \textcircled{2} and \textcircled{3} according to a change of surrounding luminance energy in the display 250 having a limited luminance energy bandwidth \textcircled{1}.

When the display 250 has a log relative energy as in \textcircled{1} and the eye's adaptation has a feature as in curve \textcircled{2}, the eye's relative response has a range of \textcircled{6}. In other words, if the eye adaptation has a feature as in curve \textcircled{2} according to the change of the surrounding lights, an image displayed on the display 250 is sensed by the eyes as a luminance energy bandwidth of \textcircled{6} range. If the vertical axis refers to white, a maximal white that can be displayed by the display 250 is 0.42. That is, an image is displayed within a very limited bandwidth.

If the luminance adjustment controller 240 dims the display 250 as in \textcircled{4} to reduce the amount of the light of the display 250 as the amount of the surrounding light decreases so that the amount of the light having eye adaptation as in curve \textcircled{2} is changed to that having eye adaptation as in curve \textcircled{3}, the luminance relative energy bandwidth of the display 250 is reduced as in \textcircled{5}. Accordingly, power consumption decreases. However, the luminance energy bandwidth that can be sensed by the eyes, is limited to \textcircled{6}.

Accordingly, if the amount of light having eye adaptation as in \textcircled{2} is changed to that having eye adaptation as in curve \textcircled{3}, the luminance energy comparator 230 compares the surrounding luminance change sensed by the luminance change sensor 220 with a preset threshold. If it is determined that the surrounding luminance change is not greater than the preset threshold by the luminance energy comparator 230, the luminance adjustment controller 240 dims the display 250 as much as a range of \textcircled{4} so that the amount of light of the display 250 is not reduced but maintained. Accordingly, the eye luminance energy bandwidth is expanded by a range of \textcircled{7}. Therefore, the maximal white that can be expressed by the display 250 is expanded to 0.64 so that a clearer and more vivid image can be displayed.

FIG. 5 is a graph for explaining a luminance controlling method of an image display apparatus according to yet another exemplary embodiment of the present invention.

FIG. 5 is a graph showing an example of changes of eye adaptation curves \textcircled{2}, \textcircled{5} and \textcircled{6} according to the change of surrounding luminance energy in the display 250 having a limited luminance energy bandwidth \textcircled{1}.

As the amount of surrounding light is changed, if the maximal luminance energy that can be sensed by the eyes falls under the maximal luminance relative energy that can be expressed by the display 250 as the eye adaptation has a feature as in curve \textcircled{2}, the luminance energy bandwidth of the display 250 is reduced. Accordingly, even if the display 250 is dimmed to reduce the amount of light, the luminance energy bandwidth sensed by the eyes is maintained. Therefore, the luminance adjustment controller 240 reduces the amount of light of the display 250 till a range of \textcircled{3}, and the power consumption can be decreased.

Additionally, if the eye adaptation has a feature as in curve \textcircled{5} as the amount of surrounding lights is changed, the adaptation curve \textcircled{5} has a maximal gradient in the luminance relative energy bandwidth \textcircled{1} that can be expressed by the display 250. Accordingly, the eyes can sense an image with the maximal luminance energy bandwidth. Therefore, in order to maintain the maximal white if the amount of surrounding lights is reduced from a time when the eyes adaptation has a feature as in curve \textcircled{5}, the luminance adjustment controller 240 controls the light amount of the display 250 to adjust the luminance.

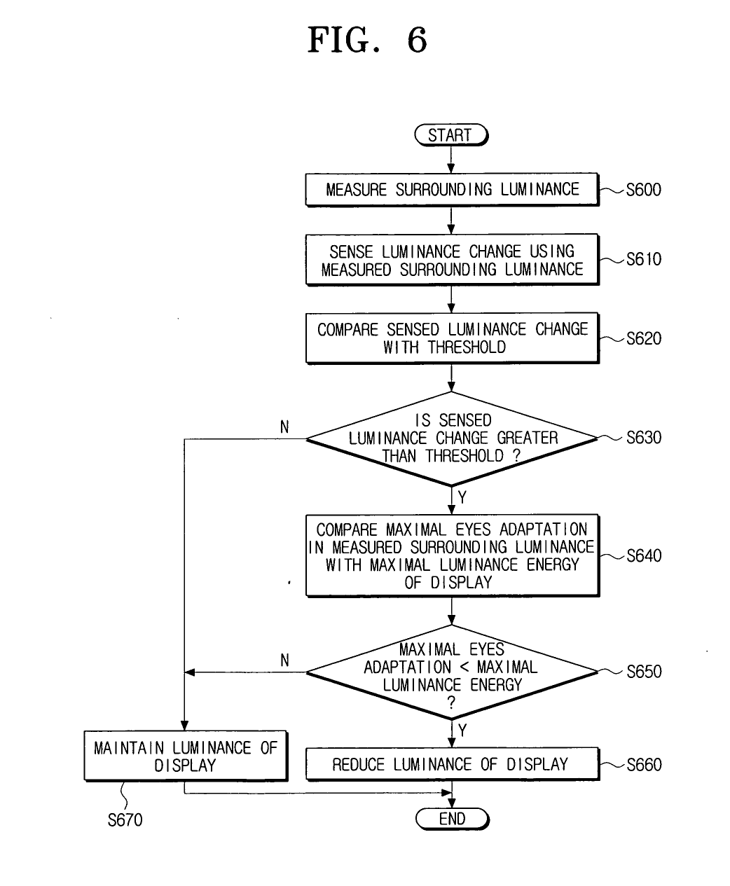

FIG. 6 is a flowchart for explaining a luminance controlling method of an image display apparatus according to an exemplary embodiment of the present invention.

Referring to FIG. 6, the luminance sensor 210 measures a surrounding luminance (S600). The luminance change sensor 220 senses a change of the surrounding luminance based on the surrounding luminance measured by the luminance sensor 210 (S610).

The luminance energy comparator 230 compares the change of the surrounding luminance sensed by the luminance change sensor 220 with the preset threshold (S620) and determines if the surrounding luminance is changed greater than the preset threshold (S630).

If the luminance energy comparator 230 determines that the surrounding luminance is changed greater than the preset threshold (S630-Y), the luminance energy comparator 230 compares the maximal eye adaptation in the measured surrounding luminance with the maximal luminance energy of the display 250 (S640). The luminance energy comparator 230 determines if the maximal eye adaptation is less than the maximal luminance energy of the display 250 (S650).

If the luminance energy comparator 230 determines that the maximal eye adaptation is less than the maximal luminance energy (S650-Y), the luminance adjustment controller 240 reduces the luminance of the display 250 (S660).

If the luminance energy comparator 230 determines that the sensed change of the surrounding luminance is not greater than the preset threshold (S630-N), or the maximal eye adaptation is not less than the maximal luminance energy (S650-N), the luminance adjustment controller 240 maintains the luminance of the display 250 (S670).

As described above, according to exemplary embodiments of the present invention, the luminance of the display is adjusted in view of the luminance energy bandwidth that can be expressed by the display, the luminance energy bandwidth that can be sensed by the eyes and the eye adaptation according to the change of the surrounding luminance. Accordingly, a clearer and more vivid image can be displayed and power consumption can be reduced.

While the invention has been shown and described with reference to certain exemplary embodiments thereof, it will be understood by those skilled in the art that various changes in form and details may be made therein without departing from the spirit and scope of the invention as defined by the appended claims.

1. An image display apparatus comprising:
a luminance sensor which measures a surrounding luminance;
a luminance change sensor which senses a change of the surrounding luminance based on the measured surrounding luminance;
a luminance energy comparator which compares the sensed change of the surrounding luminance with a preset threshold; and
a luminance adjustment controller which adjusts a luminance of a display according to an eye adaptation using a result of the comparison of the sensed change of the surrounding luminance with the preset threshold by the luminance energy comparator.

2. The apparatus as claimed in claim 1, wherein the luminance adjustment controller maintains the luminance of the display if the sensed change of the surrounding luminance is less than the preset threshold.

3. The apparatus as claimed in claim 1, wherein the luminance energy comparator compares a maximal eye adaptation in the measured surrounding luminance with a maximal luminance energy of the display if the sensed change of the surrounding luminance is greater than the preset threshold, and the luminance adjustment controller adjusts the luminance of the display according to a result of the comparison of the maximal eye adaptation in the measured surrounding luminance with the maximal luminance energy of the display.

4. The apparatus as claimed in claim 3, wherein the luminance adjustment controller maintains the luminance of the display if the maximal eye adaptation in the measured surrounding luminance is greater than the maximal luminance energy of the display, and reduces the luminance of the display if the maximal eye adaptation in the measured surrounding luminance is less than the maximal luminance energy of the display.

5. The apparatus as claimed in claim 3, wherein, in a range where the luminance energy bandwidth that can be sensed by an eye becomes wide if the surrounding luminance is changed, the luminance adjustment controller maintains the luminance of the display to expand the luminance energy bandwidth the eye.

6. The apparatus as claimed in claim 3, wherein the luminance adjustment controller adjusts the luminance of the display according to the eye adaptation from a time when the luminance energy of the display becomes maximal according to the change of the surrounding luminance.

7. The apparatus as claimed in claim 1, wherein the eye adaptation is an adaptability degree of the eye for the change of surrounding luminance based on a time that a luminance energy is incident on the eyes.

8. A luminance controlling method of an image display apparatus, the method comprising:
measuring a surrounding luminance;
sensing a change of the surrounding luminance based on the measured surrounding luminance;
comparing the sensed change of the surrounding luminance with a preset threshold; and
adjusting a luminance of a display according to a result of the comparing the sensed change of the surrounding luminance with the preset threshold.

9. The method as claimed in claim 8, wherein if it is determined that the sensed changed of the surrounding luminance is less than the preset threshold, the adjusting the luminance of the display comprises maintaining the luminance of the display.

10. The method as claimed in claim 8, further comprising comparing a maximal eye adaptation in the measured surrounding luminance with a maximal luminance energy of the display if the sensed change of the surrounding luminance is greater than the preset threshold, wherein the adjusting luminance of the display comprises adjusting the luminance of the display according to a result of the comparing the maximal eye adaptation in the measured surrounding luminance with the maximal luminance of the display.

11. The method as claimed in claim 10, wherein the adjusting the luminance maintains the luminance of the display if the maximal eye adaptation in the measured surrounding luminance is greater than the maximal luminance energy of the display, and reduces the luminance of the display if the maximal eye adaptation in the measured surrounding luminance is less than the maximal luminance energy of the display.

12. The method as claimed in claim 10, wherein, in a range where the luminance energy bandwidth that can be sensed by an eye becomes wide if the surrounding luminance is changed, the operation of adjusting the luminance maintains the luminance of the display to expand the luminance energy bandwidth of the eye.

13. The method as claimed in claim 10, wherein the operation of adjusting the luminance adjusts the luminance of the display according to the eye adaptation from a time when the luminance energy of the display becomes maximal according to the change of the surrounding luminance.

14. The method as claimed in claim 10, wherein the eye adaptation is an adaptability degree of the eye for the change of the surrounding luminance based on a time that a luminance energy is incident on the eyes.

15. An image display system comprising:
means for measuring surrounding luminance;
means for sensing a change of the surrounding luminance based on the measured surrounding luminance;
means for comparing the sensed change of the surrounding luminance with a preset threshold; and
means for adjusting luminance of a display according to an eye adaptation using a result of the comparison of the sensed change of the surrounding luminance with the preset threshold by the means for comparing.

16. The system as claimed in claim 15, wherein the luminance adjustment means maintains the luminance of the display if the sensed change of the surrounding luminance is less than the preset threshold.

17. The system as claimed in claim 15, wherein the luminance energy comparing means compares the maximal eye adaptation in the measured surrounding luminance with the maximal luminance energy of the display if the sensed change of the surrounding luminance is greater than the preset threshold and the luminance adjustment means adjusts the luminance of the display according to a result of the comparison of the maximal eye adaptation in the measured surrounding luminance with the maximal luminance energy of the display.

18. The system as claimed in claim 17, wherein the luminance adjusting means maintains the luminance of the display if the maximal eye adaptation in the measured surrounding luminance is greater than the maximal luminance energy of the display, and reduces the luminance of the display if the maximal eye adaptation in the measured surrounding luminance is less than the maximal luminance energy of the display.

19. The system as claimed in claim 17, wherein, in a range where the luminance energy bandwidth that can be sensed by an eye becomes wide if the surrounding luminance is changed, the luminance adjusting means maintains the luminance of the display to expand the luminance energy bandwidth the eye.

20. The system as claimed in claim 17, wherein the luminance adjusting means adjusts the luminance of the display according to the eye adaptation from a time when the luminance energy of the display becomes maximal according to the change of the surrounding luminance.

21. The system as claimed in claim 15, wherein the eye adaptation is an adaptability degree of the eye for the change of surrounding luminance based on a time that a luminance energy is incident on the eyes.
